(19) United States
(12) Patent Application Publication
(10) Pub. No.: US 2020/0305421 A1
(43) Pub. Date: Oct. 1, 2020

(54) NANOCLAY ROOTGUARD

(71) Applicant: A.I. INNOVATIONS N.V., Corte Madera, CA (US)

(72) Inventor: Karen Ruskin Ferguson, Corte Madera, CA (US)

(21) Appl. No.: 16/832,578

(22) Filed: Mar. 27, 2020

Related U.S. Application Data
(60) Provisional application No. 62/824,926, filed on Mar. 27, 2019.

(51) Int. Cl. A01N 25/10; A01N 33/18; A01N 25/34

(52) U.S. Cl. CPC A01N 25/10; A01N 25/34; A01N 33/18

(57) ABSTRACT

Provided is a material for preventing entry of unwanted roots into a volume of soil, the material including herbicide, nanoclay, and polymer.

### CROSS-REFERENCE TO RELATED APPLICATION(S)

This patent application claims priority to and the benefit of U.S. Provisional Patent Application No. 62/824,926, filed on Mar. 27, 2019, entitled NANOCLAY ROOTGUARD, the entire contents of which is incorporated herein by reference.

### FIELD

This invention relates generally to products used for root barriers and/or weed control.

### BACKGROUND

Driplines, or irrigation lines, may be used to deliver water and/or nutrients to plants, trees, and other foliage. However, roots of the plants, trees, unwanted weeds, etc. that are in the vicinity of the dripline, such as in the vicinity of a drip emitter of a dripline, may intrude into the dripline (e.g., through the drip emitter), thereby potentially inhibiting or blocking water flow through the dripline. Further, roots may protrude under pavement and asphalt (e.g., sidewalks, roadways, etc.), and may potentially push surfaces of the pavement and asphalt upwards. Accordingly, a barrier may be used to limit the movement of roots through the soil.

### SUMMARY

Embodiments described herein provide improvements to agriculture and landscape technology.

According to embodiments of the present disclosure, there is provided a method of creating an herbicidal zone of protection in a volume of soil to protect against unwanted root growth in the herbicidal zone of protection, the method including positioning an herbicidal root growth barrier in the volume of soil, the herbicidal root growth barrier including herbicide, nanoclay, and polymer.

The method may further include placing a subsurface irrigation line in the volume of soil, wherein positioning the herbicidal root growth barrier in the volume of soil includes surrounding one or more portions of the subsurface irrigation line with the herbicidal root growth barrier.

The one or more portions of the subsurface irrigation line may include a drip emitter of the subsurface irrigation line.

The method may further include adjusting an amount of the nanoclay to adjust an amount of time of effectiveness of the herbicide in the volume of the soil to protect against unwanted root growth in the herbicidal zone of protection, wherein reducing a concentration of the nanoclay increases a release rate of the herbicide, and wherein increasing the concentration of the nanoclay decreases the release rate of the herbicide.

The herbicide may include a dinitroanaline herbicide, trifluralin, pendimethalin, benfluralin, isopropalin, oryzalin, ethalfluralin, or profluralin.

The herbicidal root growth barrier may include about 25 wt. % herbicide, about 25 wt. % nanoclay, and about 50 wt. % polymer.

The herbicidal root growth barrier may be contained in a drip emitter or a subsurface irrigation line.

The polymer may include linear low density polyethylene.

The polymer may include a polyethylene, a polypropylene, a copolymer, or a mixture of polyethylenes and polypropylenes, polyvinylacetate, poly(ethylene vinyl acetate), poly(ethyleneacrylic acid), poly(ethylene ethyl acrylate), or polybutylene.

The nanoclay may include montmorillonite, bentonite, kaolinite, hectorite, and halloysite.

According to other embodiments of the present disclosure, there is provided a material for preventing entry of unwanted roots into a volume of soil, the material including herbicide, nanoclay, and polymer.

An amount of the nanoclay may correspond to an amount of time of effectiveness of the herbicide in preventing entry of unwanted roots into the volume of the soil, wherein reducing a concentration of the nanoclay increases a release rate of the herbicide, and wherein increasing the concentration of the nanoclay decreases the release rate of the herbicide.

The herbicide may include dinitroanaline herbicide, trifluralin, pendimethalin, benfluralin, isopropalin, oryzalin, ethalfluralin, or profluralin.

The material may include about 25 wt. % herbicide, about 25 wt. % nanoclay, and about 50 wt. % polymer.

The material may be contained in a drip emitter or a subsurface irrigation line.

The polymer may include linear low density polyethylene.

The polymer may include a polyethylene, a polypropylene, a copolymer, or a mixture of polyethylenes and polypropylenes, polyvinylacetate, poly(ethylene vinyl acetate), poly(ethyleneacrylic acid), poly(ethylene ethyl acrylate), or polybutylene.

The nanoclay may include montmorillonite, bentonite, kaolinite, hectorite, and halloysite.

According to other embodiments of the present disclosure, there is provided a material for preventing entry of unwanted roots into a volume of soil, the material including a flexible carrier sheet including layered segments including herbicide, nanoclay, and polymer spaced apart on an outer surface of the flexible carrier sheet, and being configured to retain and control a release rate of the herbicide, a barrier material on the layer segments, and an uncoated exposed outer surface between the layered segments, wherein the barrier material is configured to block diffusion of the herbicide directly therethrough to cause substantially all of the herbicide to be distributed away from the layered segments laterally through the flexible carrier sheet, and away from the uncoated exposed outer surface into the volume of soil at the controlled release rate.

An amount of the nanoclay may correspond to an amount of time of effectiveness of the herbicide for preventing entry of unwanted roots into the volume of the soil, wherein reducing a concentration of the nanoclay in the layered segments increases a release rate of the herbicide, and wherein increasing the concentration of the nanoclay in the layer segments decreases the release rate of the herbicide.

Accordingly, the method and material of embodiments of the present disclosure is able reduce or eliminate root intrusion into subsurface irrigation lines by preventing entry of unwanted roots into a volume of soil near the subsurface irrigation lines, thereby extending the lifespan associated with such irrigation lines while reducing upkeep and maintenance associated therewith, thereby improving agricultural technology.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a cross-sectional top view of a tree and its roots adjacent a root barrier and a subsurface irrigation line, according to some embodiments of the present disclosure; and

FIG. 2 is a cross-sectional side view of the tree and its roots adjacent the root barrier and the subsurface irrigation line of FIG. 1 taken along the line II-II′.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown in order to facilitate a less obstructed view of these various embodiments and to make the description clear.

### DETAILED DESCRIPTION

Features of the inventive concept and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects and features of the present inventive concept to those skilled in the art. Accordingly, processes, elements, and techniques that are not necessary to those having ordinary skill in the art for a complete understanding of the aspects and features of the present inventive concept may not be described.

Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When a certain embodiment may be implemented differently, a specific process order may be performed differently from the described order. For example, two consecutively described processes may be performed substantially at the same time or performed in an order opposite to the described order.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As described above, roots of the plants, trees, unwanted weeds, etc. that are in the vicinity of a dripline, such as in the vicinity of a drip emitter/dripper of a dripline, may intrude into the dripline (e.g., through the drip emitter), thereby potentially inhibiting or blocking water flow through the dripline.

Accordingly, there may be benefit in providing systems and methods for inhibiting root growth in areas near a dripline, such as areas around or near respective drip emitters of the dripline, to thereby reduce or prevent root intrusion into the dripline.

Conventionally, a dripline for sub-surface drip applications (e.g., irrigation purposes for watering foliage) may include technology that works in or near the drip emitter to inhibit root intrusion into the dripper. An example of such technology is referred to by the tradename of Rootguard®. Accordingly, Rootguard® technology works in the drip emitter to inhibit root intrusion.

A formula for Rootguard® (e.g., ROOTGUARD® Masterbatch) may be as follows: about 25% dinitroanaline herbicide (e.g., trifluralin, pendimethalin or benfluralin); about 25% carbon black; and about 50% polymer (e.g., linear low density polyethylene). The provided percentages may be by weight (e.g., wt. %).

The carbon black portion of the Rootguard® formula may hold the herbicide of the formula in place, and may only slowly release the herbicide (e.g., it may be 100 years or more before all of the herbicide is released from the formula into the soil).

Rootguard® may be blended with polyethylene in a ratio depending on both the design of the product and the planned life of the product. For example, if the end product is a medium-cost dripline used in growing alfalfa, then the planned life of the product would be about seven years. If the end product is a premium-cost dripline, and if the crop is orange trees, then the planned life of the product would be twenty years or more.

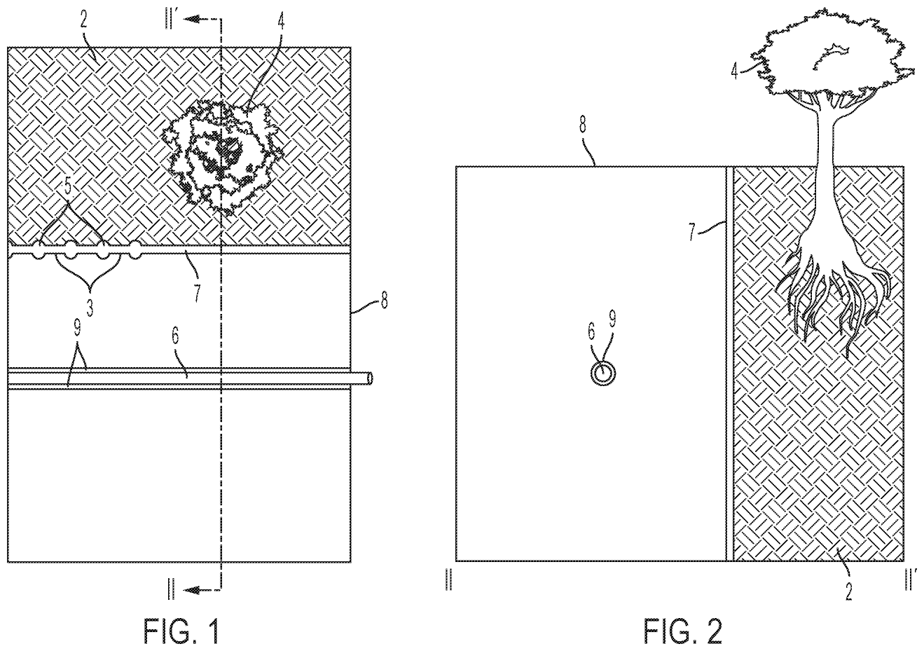

If the application of the formula applies to a root barrier (e.g., see root barrier 7, 9 placed in soil 8, in FIGS. 1 and 2), such as that which is taught in U.S. Pat. No. 8,689,484 (discussed further below), and if the application is intended to prevent roots for one hundred years or more (e.g., to keep roots out of a nuclear waste burial site), then the Rootguard® may be used undiluted thereby having the maximum quantity of herbicide available. As the herbicide builds up in the soil immediately next to the source, the source builds up a vapor pressure that slows down the rate of emission of the herbicide from the source.

However, the carbon black used in the Rootguard® formula may generally be very soft and fluffy. Accordingly, the carbon black may be difficult to handle in a mixing process, may pollute the air during the mixing process, and may cover nearby machinery and other items in black powder as a result of the mixing process. Thus, the compounding process associated with preparing Rootguard® may be expensive and unappealing. Further, because of the presence of carbon black, all products produced using the Rootguard® will be generally black in color irrespective of the designed life and application of the product.

Embodiments of the present disclose provide a formula or material for use as a root barrier, the formula replacing the above the carbon black included in the Rootguard® compound/formula discussed above with one or more nanoclays (e.g., a compound including about 25% dinitroanaline herbicide (e.g., trifluralin, pendimethalin or benfluralin); about 25% nanoclay; and about 50% polymer (e.g., linear low density polyethylene)).

After mixing the above formula, the formula may be mixed with a resin (e.g., the formula may be mixed with ployethylene or polyolefin). If the formula is to be used in a rigid application (e.g., as part of a pipe or dripline), then the formula may be mixed with a high-density nanomolecular white resin. Conversely, if the use of the formula is intended to be less rigid (e.g., used in simple fill), the formula may be mixed with a low-density broad molecular white resin.

Further, an effective lifespan of the formula may be modified by adjusting an amount of resin with which it is mixed. Accordingly, depending on the application of the formula, the amount of formula that is mixed with the resin may be adjusted. For example, if the application of the formula is intended to last for around twenty years, then about one part of the formula may be mixed with about three parts resin. If the application of the formula is intended to last an extended or maximum amount of time (e.g., one hundred years or more), then the formula may be used without being mixed with any resin.

Also, by replacing the carbon black with one or more nanoclays, different colors may be used to color code the mixture according to the expected lifespan of the formula of embodiments of the present disclosure. For example, a mixture having a red color may correspond to a product expected to be effective for only five years, while a mixture having a green color may correspond to a product expected to be effective for twenty years, etc., noting that any of various colors may be used to respectively represent any of various time frames corresponding to the expected lifespan up to a maximum expected lifespan.

Nanoclays are nanoparticles of layered mineral silicates. Nanoclays may depend on chemical composition and nanoparticle morphology. Nanoclays may be organized into several classes, such as montmorillonite, bentonite, kaolinite, hectorite, and halloysite. Nanoclays may be used in products, such as packaging products, to make the product more opaque to oxygen going in, or anything stored in the package going out, of the package (e.g., to make the packaging product less permeable).

FIG. 1 is a cross-sectional top view of a tree and its roots adjacent a root barrier and a subsurface irrigation line/drip irrigation line, according to some embodiments of the present disclosure, and FIG. 2 is a cross-sectional side view of the tree and its roots adjacent the root barrier and the subsurface irrigation line of FIG. 1 taken along the line II-II′.

Referring to FIGS. 1 and 2, nanoclays may include nanometer-sized clay particles that can be incorporated into a polymeric host carrier to assist in providing a barrier 7, 9 against root 2 infiltration of a tree 4 that is intended to receive water or nutrients from a subsurface irrigation line 6. The presence of the nanoclay particles in the barrier 7, 9 reduces the porosity of the polymer or may assist in providing the barrier 7, 9.

Accordingly, embodiments of the present disclosure may use nanoclay to achieve improved performance in a root barrier 7, 9 holding, retaining, or more slowly releasing dinitroanaline herbicide into the soil 8, as compared to carbon black, thereby creating an herbicidal zone of protection in a corresponding volume of the soil 8 to prevent unwanted root growth.

Accordingly, a formula for some embodiments of the present disclosure may be as follows: about 25% herbicide (e.g., dinitroanaline herbicide); about 25% nanoclay; and about 50% polymer (e.g., linear low density polyethylene). The provided percentages may be by weight (e.g., wt. %).

In some embodiments, the polymer may be selected from the group consisting of polyethylenes, polypropylenes, copolymers, and mixtures of polyethylenes and polypropylenes, polyvinylacetate, poly(ethylene vinyl acetate), poly(ethyleneacrylic acid), poly(ethylene ethyl acrylate), and polybutylene. In some embodiments, the herbicide may be dinitroanaline herbicide, and may include, trifluralin, pendimethalin, benfluralin, isopropalin, oryzalin, ethalfluralin, and/or profluralin.

Although similar amounts of the different materials of the compound may be used in comparison to the formula for Rootguard® (e.g., a concentration of about 25% nanoclay), the concentration of nanoclay may be adjusted, noting that reducing the concentration of nanoclay (while increasing the concentration of polymer and/or herbicide) will increase the release rate of the herbicide from the root barrier 7, 9 into the soil 8, while increasing the concentration of nanoclay (while decreasing the concentration of polymer and/or herbicide) will decrease the release rate of the herbicide. Further, nanoclays may also reduce a release rate of herbicide that is present in the barrier 7, 9 at elevated temperatures, which can extend product expected life.

Embodiments of the present disclosure may be used in conjunction with the embodiments disclosed in U.S. Pat. No. 5,116,414, titled LONG-TERM CONTROL OF ROOT GROWTH, the disclosure of which being incorporated herein by reference. For example, according to embodiments of the present disclosure, to achieve an extended life of a material (e.g., to achieve a reduced release rate of the herbicide), the material may be manufactured by mixing the herbicide and nanoclay together at a temperature in excess of a melting point of the herbicide, and such that herbicide is absorbed (e.g., completely absorbed) into the nanoclay. Then, the polymer may be added to the mixture, and the mixture may be passed through a compounding extruder to produce plastic granules. At room temperature, or at ambient temperature, in soil, the plastic granules may slowly release the herbicide (e.g., over 100 years or more). The compound of the plastic granules may be considered to be a Rootguard® that is diluted with plastic materials, thereby reducing both the cost while increasing the expected life of the product.

Embodiments of the present disclosure may be used in conjunction with the embodiments disclosed in U.S. Patent Application Publication No. 2016/0330918, titled ROOT INTRUSION PROTECTION OF SUBSURFACE DRIP IRRIGATION PIPE, the disclosure of which is incorporated herein by reference. For example, according to embodiments of the present disclosure, the compound/formula disclosed herein can be used in the “first layer having a releasable herbicide compound,” or can be combined with herbicide as “a suitable carrier” (instead of carbon black), and can be used to absorb “the herbicide into particles” thereof. Further, in some embodiments, the herbicide-nanoclay-polymer compound discussed above may be added to either the drip irrigation line or the drippers to be slowly released into the soil immediately adjacent to the dripline or the drippers.

Additionally, embodiments of the present disclosure may be used in conjunction with embodiments disclosed in U.S. Pat. No. 5,181,952, titled ROOT-GROWTH-INHIBITING SHEET, the disclosure of which being incorporated herein by reference. For example, according to embodiments of the present disclosure, the compound/formula disclosed herein can be pre-blended with dinitroanaline “before being mixed with the polymer.”

Furthermore, embodiments of the present disclosure may be used in conjunction with embodiments disclosed in U.S. Pat. No. 8,689,484, titled WEED CONTROL AND ROOT BARRIER, the disclosure of which being incorporated herein by reference. For example, according to embodiments of the present disclosure, the compound/formula disclosed herein can be used in the “polyolefin sheet material carries layer segments of a polymer which contains a herbicide,” and an “herbicide-containing material may be made of a mixture of thermoplastic polyolefin, such as polyethylene, and a herbicide absorbed into” nanoclay particles, “and then dispersed into the polymeric carrier material.”

As can be seen in FIG. 1, the barrier 7 may include a flexible carrier sheet including layered segments 5 that include the formula of embodiments discussed above, and that are spaced apart (e.g., at regular intervals). The layered segments 5 may be configured to control a release rate of herbicide, and may have a barrier material thereon to block diffusion of the herbicide directly therethrough. The barrier 7 may also include segments 3 of an uncoated exposed outer surface that are between respective layered segments 5. Accordingly, the barrier 7 may be a flexible sheet that may cause substantially all of the herbicide to be distributed away from the layered segments 5 laterally through the barrier, and away from the uncoated exposed outer surface segments 3 into the soil 8 at a controlled release rate.

Further still, embodiments of the present disclosure may be used in conjunction with embodiments disclosed in U.S. Pat. No. 6,821,928, titled METHOD TO REDUCE THE RATE OF DIFFUSION OF SLOW-RELEASE MATERIALS THROUGH POLYMERS AND PROCESS FOR MAKING DRIP IRRIGATION DEVICES WITH LONG-TERM CONTROL OF ROOT GROWTH, the disclosure of which being incorporated herein by reference. For example, according to embodiments of the present disclosure, a barrier layer could contain 2% nanoclay, and the type of nanoclay incorporated can be as those disclosed in U.S. Pat. No. 6,821,928.

Accordingly, as described above, embodiments of the present disclosure are able to provide improvements to agricultural technology by providing a composition that is able to control a release rate of an herbicide into soil such that the composition may prevent or inhibit unwanted root growth for up to one hundred years or more, the composition being able to be mixed with varying amounts of resin to provide for multiple practical applications

What is claimed is:

1. A method of creating an herbicidal zone of protection in a volume of soil to protect against unwanted root growth in the herbicidal zone of protection, the method comprising positioning an herbicidal root growth barrier in the volume of soil, the herbicidal root growth barrier comprising herbicide, nanoclay, and polymer.

2. The method of claim 1, further comprising placing a subsurface irrigation line in the volume of soil, wherein positioning the herbicidal root growth barrier in the volume of soil comprises surrounding one or more portions of the subsurface irrigation line with the herbicidal root growth barrier.

3. The method of claim 2, wherein the one or more portions of the subsurface irrigation line include a drip emitter of the subsurface irrigation line.

4. The method of claim 1, further comprising adjusting an amount of the nanoclay to adjust an amount of time of effectiveness of the herbicide in the volume of the soil to protect against unwanted root growth in the herbicidal zone of protection, wherein reducing a concentration of the nanoclay increases a release rate of the herbicide, and wherein increasing the concentration of the nanoclay decreases the release rate of the herbicide.

5. The method of claim 1, wherein the herbicide comprises a dinitroanaline herbicide, trifluralin, pendimethalin, benfluralin, isopropalin, oryzalin, ethalfluralin, or profluralin.

6. The method of claim 1, wherein the herbicidal root growth barrier comprises about 25 wt. % herbicide, about 25 wt. % nanoclay, and about 50 wt. % polymer.

7. The method of claim 1, wherein the herbicidal root growth barrier is contained in a drip emitter or a subsurface irrigation line.

8. The method of claim 1, wherein the polymer comprises linear low density polyethylene.

9. The method of claim 1, wherein the polymer comprises a polyethylene, a polypropylene, a copolymer, or a mixture of polyethylenes and polypropylenes, polyvinylacetate, poly(ethylene vinyl acetate), poly(ethyleneacrylic acid), poly(ethylene ethyl acrylate), or polybutylene.

10. The method of claim 1, wherein the nanoclay comprises montmorillonite, bentonite, kaolinite, hectorite, and halloysite.

11. A material for preventing entry of unwanted roots into a volume of soil, the material comprising herbicide, nanoclay, and polymer.

12. The material of claim 11, wherein an amount of the nanoclay corresponds to an amount of time of effectiveness of the herbicide in preventing entry of unwanted roots into the volume of the soil, wherein reducing a concentration of the nanoclay increases a release rate of the herbicide, and wherein increasing the concentration of the nanoclay decreases the release rate of the herbicide.

13. The material of claim 11, wherein the herbicide comprises dinitroanaline herbicide, trifluralin, pendimethalin, benfluralin, isopropalin, oryzalin, ethalfluralin, or profluralin.

14. The material of claim 11, wherein the material comprises about 25 wt. % herbicide, about 25 wt. % nanoclay, and about 50 wt. % polymer.

15. The material of claim 11, wherein the material is contained in a drip emitter or a subsurface irrigation line.

16. The material of claim 11, wherein the polymer comprises linear low density polyethylene.

17. The material of claim 11, wherein the polymer comprises a polyethylene, a polypropylene, a copolymer, or a mixture of polyethylenes and polypropylenes, polyvinylacetate, poly(ethylene vinyl acetate), poly(ethyleneacrylic acid), poly(ethylene ethyl acrylate), or polybutylene.

18. The material of claim 11, wherein the nanoclay comprises montmorillonite, bentonite, kaolinite, hectorite, and halloysite.

19. A material for preventing entry of unwanted roots into a volume of soil, the material comprising:
a flexible carrier sheet comprising:
layered segments comprising herbicide, nanoclay, and polymer spaced apart on an outer surface of the flexible carrier sheet, and being configured to retain and control a release rate of the herbicide;
a barrier material on the layer segments; and
an uncoated exposed outer surface between the layered segments,
wherein the barrier material is configured to block diffusion of the herbicide directly therethrough to cause substantially all of the herbicide to be distributed away from the layered segments laterally through the flexible carrier sheet, and away from the uncoated exposed outer surface into the volume of soil at the controlled release rate.

20. The material of claim 19, wherein an amount of the nanoclay corresponds to an amount of time of effectiveness of the herbicide for preventing entry of unwanted roots into the volume of the soil, wherein reducing a concentration of the nanoclay in the layered segments increases a release rate of the herbicide, and wherein increasing the concentration of the nanoclay in the layer segments decreases the release rate of the herbicide.
